(19) United States
(12) Patent Application Publication
(10) Pub. No.: US 2024/0074447 A1
(43) Pub. Date: Mar. 7, 2024

(54) MILK POWDER COMPOSITION

(71) Applicant: VALIO LTD, Helsinki (FI)

(72) Inventor: Kaity-Marin LEHTONEN, Helsinki (FI)

(21) Appl. No.: 18/262,208

(22) PCT Filed: Jan. 21, 2022
(86) PCT No.: PCT/FI2022/050039

§ 371 Date: Jul. 20, 2023

(30) Foreign Application Priority Data
Jan. 21, 2021 (FI) 20215073

(51) Int. Cl. A23C 9/123; A23C 9/13

(52) U.S. Cl. CPC A23C 9/1232; A23C 9/1238; A23C 9/1307

(57) ABSTRACT

A lactose free milk powder composition including a citrate preparation, a method for its production, and a method for producing a lactose free low sugar acidified milk product using the lactose free milk powder composition.

### FIELD OF THE INVENTION

The present invention relates to a milk powder composition, more particularly a lactose free milk powder composition. The invention also relates to a method for producing a lactose free low sugar acidified milk product using the lactose free milk powder composition.

### BACKGROUND OF THE INVENTION

There is a global trend for healthier eating and for overall well-being of individuals. It is widely recognized that people in developed countries eat energy-rich food with high fat and carbohydrate contents which is reflected by a great number of people with overweight or obesity. There is a growing interest of reducing sugar in food products to partly reduce the energy content of the food products.

In addition, there is a need for lactose free milk products which are suitable for lactose intolerant individuals. Indeed, low lactose or lactose-free milk products have been available in the market for many years.

There are also low sugar acidified milk products in the market. Typical adjectives describing low sugar acidified products, such as yogurts, in cases where the amount of added sugar is reduced or no sugar is added, are reduced sweetness, defects in aroma profile and excess acidity, for example. In cases where sweeteners are used, the products are characterised to have off-flavours and artificial taste.

Reduction of sugar in food products is challenging for food manufactures. The sugar reduction often results in defects in taste and may also unmask off-tastes of the food products.

WO 2013/004895 A1 discloses a milk-based powder having a ratio of carbohydrates to protein of at most 1.1, a protein content of at least 5.4% on dry matter basis and a ratio of ash to protein that is substantially similar to that of a milk raw material used as a starting material.

Acidified milk products, such as yoghurts, may be produced from fresh milk or from milk powders. The production of acidified milk products from milk powders is especially convenient in countries where fresh milk supply is limited.

It has now been found a lactose free milk powder composition that may be conveniently used in the manufacture of a low sugar and lactose-free acidified milk product. The acidified product exhibits an appealing, rich and fresh natural taste and have a yoghurt-like texture.

### BRIEF DESCRIPTION OF THE INVENTION

An object of the present invention is to provide a lactose free milk powder composition comprising a citrate preparation.

Another object of the invention is to provide a lactose free milk powder composition comprising citrate in an amount of about 1.5% to about 2.5%, specifically about 1.8% to about 2.3%, more specifically about 2.1% on dry matter basis, calculated as pure citrate.

A further object of the invention is to provide a method for producing a lactose free milk powder composition.

An object of the invention is to provide a use of a lactose free milk powder composition of the invention comprising citrate and that produced by the method of the invention in the manufacture of a lactose free low sugar acidified milk product.

An object of the invention is to provide a method for producing a lactose free low sugar acidified milk product.

It was found in the present invention that that taste defects of an acidified milk product caused by a reduced amount of sugar may be compromised by introducing citrate compound(s) to a lactose free milk powder composition. Use of a suitable acidifier in the manufacture of an acidified milk product results metabolism of citrate generating beneficial aroma compounds to the acidified milk product.

It has been known that citrate exhibits flavour characteristics in milk. It was unexpectedly found in the present invention that the total sugar content of the acidified milk product could be reduced by at least 30% by weight compared with a typical acidified milk product without negatively affecting the sensory properties, such as sweetness sensation, of the products by restoring the original citrate level of milk and producing aroma compounds from citrate using a suitable starter culture in the manufacture of an acidified lactose free milk product.

The present invention thus provides a lactose free milk powder composition which may be conveniently used by a customer in the manufacture of a lactose free low sugar acidified milk product only by adding water and culture(s) for acidification, and optionally an additional taste imparting constituent, such as a fruit preparation. A lactose free acidified milk product with a low sugar content exhibiting natural, fresh taste and yoghurt-like structure is achieved.

### BRIEF DESCRIPTION OF THE DRAWINGS

FIG. 1 shows a sensory analysis fullness of taste of a yoghurt of the invention and a reference yoghurt;

FIG. 2 shows a sensory analysis of acidity of a yoghurt of the invention and a reference yoghurt;

FIG. 3 shows the contents of an aroma compound of a yoghurt of the invention and a reference yoghurt.

FIG. 4 shows an embodiment of the method for producing a lactose free skim milk powder composition of the invention for the manufacture of low sugar lactose free yoghurt.

FIG. 5 shows an embodiment of the method for producing a lactose free whole milk powder composition of the invention for the manufacture of low sugar lactose free yoghurt.

FIG. 6 shows an embodiment of the method for producing lactose free yoghurt from the lactose free milk powder composition of the invention starting from skim milk or whole milk as a starting raw milk.

### DETAILED DESCRIPTION OF THE INVENTION

In an embodiment, the acidified low sugar milk product of the invention is a fermented low sugar milk product. In an embodiment of the invention, the lactose free low sugar acidified milk product is yoghurt. In another embodiment, the lactose free low sugar acidified milk product is quark. The invention is described in more detail below in respect of yoghurt, however without limiting the invention thereto.

The percentages of the various constituents mentioned throughout in the present application are given on weight basis.

In an aspect, the invention provides a lactose free milk powder composition comprising a citrate preparation.

In another aspect, the invention provides a lactose free milk powder composition comprising citrate in an amount of about 1.5% to about 2.5%, specifically about 1.8% to about 2.3%, more specifically about 2.1% on dry matter basis, calculated as pure citrate.

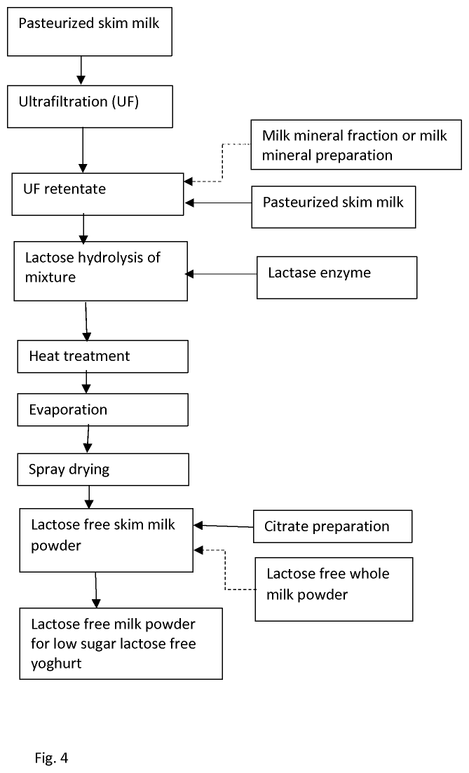

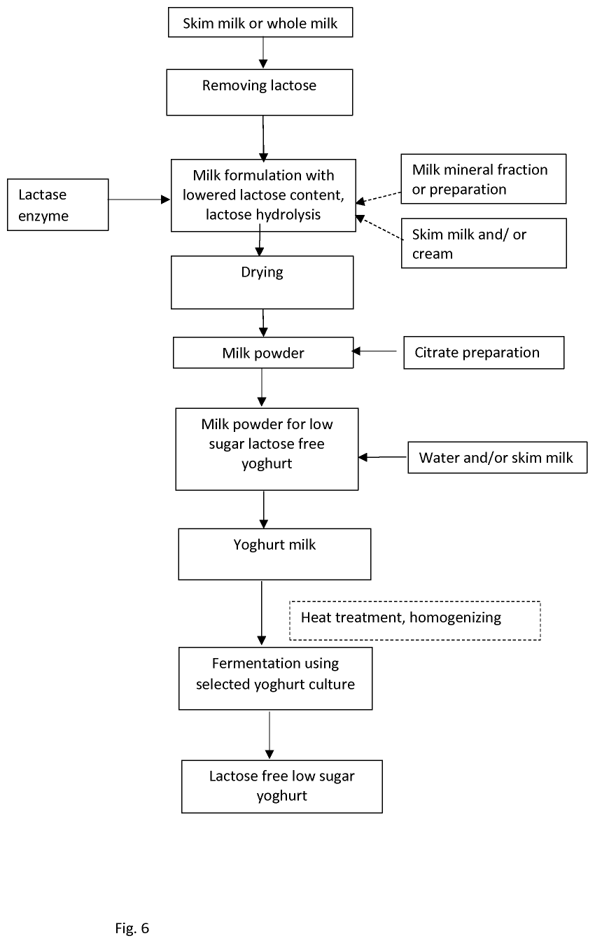

The preparation of the lactose free milk powders of the invention is illustrated in FIGS. 4-6. FIG. 6 further shows an embodiment of the method for producing a lactose free low sugar yoghurt. The dotted line in the figures indicate optional features of the inventions.

Generally, a milk raw material is subjected to a step in which lactose is removed and protein is respectively increased to provide a lactose-reduced milk. Optionally, milk mineral preparation, skim milk, whole milk and/or cream is/are added to the lactose-reduced milk. Lactase enzyme is added to the lactose-reduced milk to hydrolyse residual lactose. The lactose-hydrolyzed milk is then dried to powder followed by addition of a citrate preparation to the resultant lactose free milk powder.

The milk raw material used in the preparation of the lactose free milk powder may be skim milk or whole milk. The fat content of the milk raw material may vary from about 0.1% to about 4.7%. In an embodiment, the milk raw material is bovine milk. In an embodiment, the milk raw material is pasteurized.

In the present invention, the lactose free milk powder is produced from lactose free milk. In an embodiment, the lactose free milk is produced by removing lactose from a milk raw material using membrane filtration. In an embodiment, the milk raw material is bovine milk typically having a lactose content of about 4.5%. In an embodiment, the milk raw material, such as skim milk or whole milk, is subjected to ultrafiltration to concentrate milk protein to a retentate while a substantial portion of lactose transfers through an ultrafiltration membrane to a permeate. Residual lactose remained in the milk protein concentrate is hydrolysed by a lactase enzyme to decomposition products of lactose, i.e., glucose and galactose. Glucose has a higher index of sweetness than lactose. Therefore, the ultrafiltered milk protein concentrate containing glucose, and galactose, used in the production of an acidified milk product beneficially imparts sweetness to the product and contributes to sugar reduction.

The lactose removal of milk may be carried out, for example, following the method described in WO 03/094623 A1. The publication discloses separation of milk protein, lactose and milk minerals into separate fractions using ultrafiltration, nanofiltration and reverse osmosis.

In addition to lactose, a portion of citrate and milk minerals, in particular monovalent milk minerals, naturally present in milk are transferred into an ultrafiltration permeate. In order to retain beneficial influences provided by citrate to the organoleptic properties of milk, a citrate preparation is added to a citrate-reduced lactose free milk powder composition.

In ultrafiltration of a milk raw material, fat of milk is retained in the retentate besides protein. Depending on the fat content of milk subjected to ultrafiltration, the fat content of the milk protein concentrate may vary. The milk protein concentrate may be produced from whole milk or skimmed milk, for example.

In an embodiment, the milk protein concentrate, such as an ultrafiltration retentate, is mixed with milk, cream and milk mineral preparation to adjust the protein, fat and mineral contents of the concentrate to appropriate levels.

In an embodiment, the resultant mixture with an appropriate composition is subjected to heat treatment, such as pasteurisation.

The mixture with a lactose content of about 4.7% to about 4.9% is then hydrolyzed by adding lactase enzyme to the mixture. The lactose hydrolysis is carried out in manner well known to a skilled person.

After lactose hydrolysis of the mixture, the mixture is dried to powder. Drying may be carried out at any conventional method in the art and belongs to the knowledge of a skilled person, for example by evaporation and/or spray-drying to provide a lactose free milk powder composition.

Thus, in an aspect, the present invention provides a method for producing lactose free milk powder composition comprising the steps of:
providing a milk raw material,
reducing the lactose content of the milk raw material to provide a lactose-reduced milk raw material,
adding at least one of milk, cream and milk minerals to the lactose-reduced milk raw material,
subjecting the lactose-reduced milk raw material to lactose hydrolysis to provide a lactose free milk formulation,
drying the lactose free milk formulation to provide a powdered lactose free milk formulation,
adding a citrate preparation to the powdered lactose free milk formulation to provide a lactose free milk powder composition.

In an embodiment, natural level of citrate of a milk raw material is reduced when lactose content of the milk raw material is reduced by using membrane filtration, such as ultrafiltration.

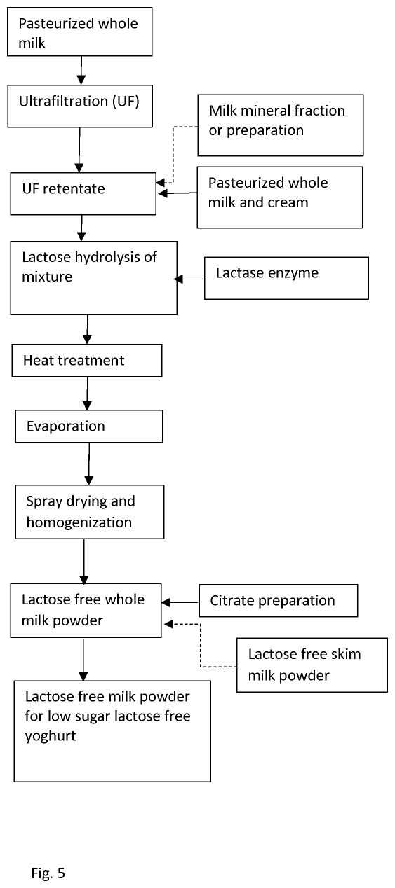

According to an embodiment of the invention, the lactose free milk powder of the invention is produced as follows: The milk powder suitable as an ingredient in composing the lactose free milk powder composition of the invention is prepared with a process shown in FIGS. 4 and 5. Pasteurized skim milk or pasteurized whole milk with typical lactose content is subjected to ultrafiltration to provide ultrafiltration retentate with reduced lactose content. Milk mineral fraction or milk mineral preparation is added to the UF retentate in an amount suitable for at least partly compensating milk mineral loss to the ultrafiltration permeate. A milk mineral fraction or a milk mineral preparation is optionally added to the ultrafiltration retentate. Pasteurized skim milk is added to the ultrafiltration retentate to compose a suitable milk composition for enzymatic lactose hydrolysis step and further to heat treatment, evaporation and spray drying. The lactose free milk powder composition of the present invention is prepared from the spray dried milk powder and citrate preparation(s).

According to another embodiment of the invention, the lactose free milk powder of the invention is produced as follows: The milk powder suitable as an ingredient in composing the lactose free milk powder composition of the invention is prepared with a process shown in FIGS. 4 and 5. Pasteurized skim milk or pasteurized whole milk with typical lactose content is subjected to ultrafiltration to provide ultrafiltration retentate with reduced lactose content. Milk mineral fraction or milk mineral preparation is added to the ultrafiltration retentate in an amount suitable for at least partly compensating milk mineral loss to the ultrafiltration permeate. A milk mineral fraction or a milk mineral preparation is optionally added to the ultrafiltration retentate. Pasteurized skim milk is added to the ultrafiltration retentate to compose a suitable milk composition for enzymatic lactose hydrolysis step and further to heat treatment, evaporation and spray drying. The lactose free milk powder composition of the invention is composed from lactose free skim milk powder, the process shown in FIG. 4, lactose free whole milk powder, the process shown in FIG. 5, and citrate preparation(s). The mass ratios of the lactose free skim milk powder and the lactose free whole milk powder in the lactose free milk powder composition of the invention is selected in a ratio which results in total fat composition of the milk powder of the invention between 1%-30%.

The milk powders suitable for composing the lactose free milk powder composition of the invention are lactose free skim milk powders with less than 5% of moisture and with less than 1.5% of milk fat (or any fat), and lactose free whole milk powders with less than 4.5% of moisture and 26% of milk fat (or any fat) at minimum and 42% at maximum.

According to an embodiment of the invention, the lactose free low sugar yoghurt is produced from the lactose free milk powder composition of the invention (the process flow chart shown in FIG. 6). The lactose free milk powder composition of the invention is reconstituted in water of skim milk or in a mixture of skim milk and water to provide a yoghurt milk. The reconstituted milk (which is yoghurt milk) is subjected to typical heat treatment and homogenizing steps when needed and in accordance with normal dairy processing techniques. The yoghurt milk is subjected to fermentation where a specific biological starter culture, or a specific mixture of biological starter cultures, is used. The pH of the yoghurt at the end of the fermenting step is between 4.4 and 4.6.

In order to restore advantageous effects provided by citrate on the organoleptic properties of milk, citrate preparation is added to the lactose free milk powder composition in an amount of 1% to about 3%. In an embodiment, the added amount of citrate preparation is about 2%.

The lactose free milk powder composition produced by the method of the invention comprises citrate in an amount of about 1.5% to about 2.5%, specifically about 1.8% to about 2.3%, more specifically about 2.1% on dry matter basis, calculated as pure citrate.

In an embodiment, the citrate preparation is a commercially available product. In another embodiment, the citrate preparation is a citrate isolated from milk. In an embodiment, the citrate preparation is selected from sodium citrate, potassium citrate and a mixture thereof.

The lactose free milk powder composition of the invention is predominantly composed of citrate preparation(s), and at least one of lactose free skim milk powder and lactose free whole milk powder. In an embodiment, the lactose free milk powder composition consists of milk proteins, milk-derived carbohydrates, milk-derived fat, and citrate preparation(s). The carbohydrates of the lactose free milk powder composition are mainly constituted by decomposition products of lactose, i.e., glucose and galactose, but may include a small amount of residual lactose. The lactose free milk powder composition contains carbohydrates in an amount of about 30% to about 40%. In an embodiment, the amount of carbohydrates is about 34%.

In an embodiment, the lactose free milk powder composition contains about 30% to about 40% of glucose and galactose in total. In an embodiment, the total amount of glucose and galactose is about 34%.

The term “lactose free” means that the lactose content of the milk powder composition is at most 0.1%. In an embodiment, the lactose content is at most 0.06%.

The protein content of the lactose free milk powder composition is in the range of about 30% to about 50%. In an embodiment, the protein content is about 35% to about 40%. In another embodiment, the protein content is about 36%.

The lactose free milk powder composition may contain whole milk powder or skim milk powder or both of them. The fat of the lactose free milk powder composition is in the range of about 1% to about 30%. In an embodiment, the fat content is about 20%.

The ash content of the lactose free milk powder composition is in the range of about 6% to about 10%. In an embodiment, the ash content is about 7.0%. The sodium content of the lactose free milk powder composition is in the range of about 300 mg/100 g to about 500 mg/100 g. In an embodiment, the content is about 370 mg/100 g.

The potassium content of the lactose free milk powder composition is in the range of about 1400 mg/100 g to about 2000 mg/100 g. In an embodiment, the content is about 1100 mg/100 g.

The calcium content of the lactose free milk powder composition is in the range of about 1000 mg/100 g to about 1500 mg/100 g. In an embodiment, the content is about 1100 mg/100 g.

The magnesium content of the lactose free milk powder composition is in the range of about 90 mg/100 g to about 120 mg/100 g. In an embodiment, the content is about 100 mg/100 g.

The phosphorus content of the lactose free milk powder composition is in the range of about 700 mg/100 g to about 110 mg/100 g. In an embodiment, the content is about 870 mg/100 g.

The chloride content of the lactose free milk powder composition is in the range of about 900 mg/100 g to about 1400 mg/100 g. In an embodiment, the content is about 1000 mg/100 g.

The sodium chloride content of the lactose free milk powder composition is in the range of about 0.8% to about 1.3%. In an embodiment, the content is about 0.9%.

The energy content of the lactose free milk powder composition is in the range of about 1500 kJ/100 g to about 2100 kJ/100 g. In an embodiment, the content is about 1900 kJ/100 g.

In an aspect, the invention provides a use of lactose free milk powder compositions of the invention or that produced by the method of the invention in the manufacture of a lactose free low sugar acidified milk product. In an embodiment, the lactose free milk powder composition is used in an amount of about 7% to about 15% in the lactose free low sugar acidified milk product. In another embodiment, the lactose free milk powder composition is used in an amount of about 9% to about 13%. In a further embodiment, the lactose free milk powder composition is used in an amount of about 11.5%.

The lactose free milk powder composition contains all essential compounds needed for the production of a lactose free low sugar acidified milk product except a liquid, such as water, and a starter culture. The invention thus provides an ingredient which is conveniently further processed to a lactose free acidified milk product only by adding a liquid and a starter culture. A lactose free acidified milk product with low sugar is obtained. If desired, further constituents, such as taste imparting agents, like jam, fruits, berries, syrup, honey, aroma compounds (vanilla, lemon), vitamins etc., may also be added to a lactose free acidified milk product.

In an aspect, the invention provides a method for producing a lactose free low sugar acidified milk product. The method of the invention comprises the steps of:
providing a lactose free milk powder composition of the invention or that produced by the method of the invention,
mixing the lactose free milk powder composition with a liquid to provide a lactose free yoghurt milk,
homogenizing the lactose free yoghurt milk,
pasteurizing the lactose free yoghurt milk,
fermenting the yoghurt milk with a yoghurt culture to provide a lactose free low sugar acidified milk product.

The lactose free yoghurt milk is formed from a lactose free milk powder composition of the invention or that produced by the method of the invention and a liquid. The liquid may be water or a milk raw material, such as skim milk. In an embodiment, the liquid is lactose-free milk raw material. In an embodiment, the liquid is water. Optionally, cream and taste imparting agents, such an artificial, non-caloric sweetener may be included in the yoghurt milk. Cream may be added to adjust the fat level of the lactose free low sugar free acidified milk product to a desired level between about 0.1% to about 10%.

The lactose free milk powder composition is added to the liquid in an amount of about 11% based on weight of the resultant lactose free yoghurt milk.

In an embodiment, the fermentation is carried out at a temperature of about 30° C. to about 42° C. In another embodiment, the fermentation is carried out at about 38° C.

In an embodiment, the fermentation is carried out until pH of about 4.4 to about 4.6. In an embodiment, the fermentation is carried out until pH of about 4.6 is reached.

The lactose free yoghurt milk comprises protein in an amount of about 2.5% to about 8%. In one embodiment, the amount of protein is about 3% to about 5%. In another embodiment, the amount of protein is about 2.5% to about 4.5%. In a further embodiment, the amount of protein is about 3.5% to about 4.5%.

The fat content of the lactose free yoghurt milk is about 0.1% to about 10%.

The lactose content of the lactose free yoghurt milk is at most about 0.01%.

The lactose free yoghurt milk comprises ash in an amount of about 0.5% to about 1%. In an embodiment, the amount of ash is about 0.8%.

The lactose free yoghurt milk standardized to desired protein, fat, lactose and ash contents is then homogenized in a conventional manner. In an embodiment, homogenization is carried out at 60° C. and at 50/150 bar.

The lactose free yoghurt milk is heat-treated using methods known per se. Useful heat-treatment processes are, among others, pasteurisation, high-pasteurisation, thermisation, UHT treatment and ESL treatment. Examples of suitable heat-treatments include heating at 80° C.-90° C. for 15 seconds to 10 minutes, UHT treatment at 120° C.-150° C. for 1 to 6 seconds and ESL treatment at 135° C. for 0.5 seconds. The heat-treatment may also be performed in several steps. In one embodiment, the heat treatment is performed also as a post-heat treatment, specifically as thermisation and/or as pasteurisation for yoghurt or quark. In an embodiment, the yoghurt milk is pasteurized at 85° C. for 5 minutes.

After homogenization and pasteurization, the lactose free yoghurt milk is subjected to fermentation by utilising biological starter cultures specific to each product (e.g., bulk starter or direct to vat starter DVI/DVS). The starter culture is selected from lactic acid bacteria including Lactobacillus delbrueckii subsp. bulgaricus and Streptococcus thermophilus and a mixture thereof. In addition, lactic acid bacteria strain that are capable of metabolizing citrate to aroma compounds are used in the method. The aroma compounds include acetoin, diacetyl, acetaldehyde, and acetate. These strains can include Lactobacillus rhamnosus, Lactococcus lactis subsp. lactis biovar. diacetylactis and Leuconostoc species.

Also strains Lactobacillus plantarum and L. casei have capability of converting citrate to aroma compounds. These strains can be used together with lactic acid bacteria strain in the fermentation.

Citrate is thus beneficially utilized in the method of the invention by metabolizing citrate by a starter culture to various taste imparting substances. Diacetyl is an important aroma compound that gives a distinct flavour to yoghurt. Diacetyl contributes a delicate, full flavour to yoghurt.

By carrying out the method of the invention using a lactose free milk powder composition of the invention it is possible to decrease the total sugar content of a lactose free acidified milk product by about 30% compared with flavored yoghurts available in the market. The total sugar content of the lactose free low sugar acidified milk product is in the range of about 4% to about 8.4%. In the context of the present invention, the term “sugar” encompasses saccharose (also called sucrose or table sugar), any residual lactose, glucose, galactose and fructose. The total sugar content of the yoghurt may be provided in the yoghurt, for example, by adding jam, fruits, berries, syrup, honey, or any other suitable sugar containing substances. Glucose and galactose are appropriately provided by hydrolysis of lactose.

The saccharose in the form of jam, fruits and/or berries, for example, may be added to the final lactose free low sugar acidified milk product after the fermentation.

In an embodiment, after fermentation, the resultant lactose free low sugar acidified milk product is smoothened, cooled to about room temperature and packed to suitable containers.

The lactose free low sugar acidified milk product produced by the method of the invention contains protein in an amount of about 2.5% to about 8%. In another embodiment, the amount of protein is about 3% to about 5%. In a further embodiment, the amount of protein is about 2.5% to about 4.5%. In a still further embodiment, the amount of protein is about 3.5% to about 4.5%.

The fat content of the lactose free low sugar acidified milk product is about 0.1% to about 10%.

The lactose content of the lactose free low sugar acidified milk product is at most about 0.01%.

The lactose free low sugar acidified milk product contains ash in an amount of about 0.5% to about 1%. In an embodiment, the amount of ash is about 0.8%.

The energy content of the lactose free low sugar acidified milk product is in the range of about 80 kJ/100 g lactose free low sugar acidified product to about 550 kJ/100 g lactose free low sugar acidified product. In an embodiment, the energy content is about 290 kJ.

In an embodiment, the lactose free low sugar acidified milk product produced by the method of the invention contains about 4% of protein, about 2% of fat and about 8.4% of sugars in total. In an embodiment, the low sugar acidified milk product is yoghurt.

The lactose free low sugar acidified milk product produced by the method of the invention contains lactose at most of 0.01% reflecting a lactose free milk product.

The following examples are presented for further illustration of the invention without limiting the invention thereto.

Citrate was measured according to a method IDF 34C:1992 and performed with enzymatic Boehringer Mannheim UV-test Cat. no. 10 139 076 035.

### Example 1

Lactose free milk powders were produced from both whole milk and skim milk. Lactose free skim milk powder was produced by subjecting skim milk to ultrafiltration to provide a skim milk protein concentrate. The skim milk contained 3.6% of protein, 0.07% of fat, 4.6% of lactose, 0.8% of ash, and 0.18% of citrate. The dry matter of the skim milk was 9%. The skim milk protein concentrate contained 12.4% of protein, 0.2% of fat, 4.1% of lactose, 1.4% of ash, and 0.15% of citrate. The dry matter of the concentrate was 18%.

Pasteurized skim milk was added to the concentrate to provide a mixture. 1 kg of a lactase enzyme was then added to 1000 L of the mixture to hydrolyse lactose. The hydrolysed mixture was heat-treated at 75° C., evaporated at 230 mbar and spray dried at 173° C.

Lactose free whole milk powder was produced by subjecting whole milk having a fat content of 4% to ultrafiltration to provide a whole milk protein concentrate. Milk having 4% of fat, and cream having 40% of fat were added to the milk protein concentrate to provide a mixture having a lactose content of 4.7%. 1 kg of a lactase enzyme was then added to 1000 L of the mixture to hydrolyse lactose. The resultant hydrolysed mixture was heat-treated at 75° C. and evaporated at 230 mbar followed by homogenization at 120 bar. The homogenized mixture was spray dried at 160° C.

The nutritional data of the lactose free milk powders are given in Table 1.

TABLE 1

| | Lactose free skim | Lactose free whole |
|---|---|---|
| | milk powder | milk powder |
| Protein (%) | 47 | 32 |
| Fat (%) | 1 | 27 |
| Ash (%) | 9.0 | 6.3 |
| Na (mg/100 g) | 460 | 340 |
| K (mg/100 g) | 1900 | 1400 |
| Ca (mg/100 g) | 1400 | 1000 |
| Mg (mg/100 g) | 120 | 91 |
| P (mg/100 g) | 1100 | 790 |
| Cl (mg/100 g) | 1300 | 960 |
| NaCl (%) | 1.2 | 0.85 |
| Carbohydrates (%) | 40 | 32 |
| Lactose (%) | 0.06 | 0.06 |
| Glucose (%) | 19 | 16 |
| Galactose (%) | 19 | 15 |
| Citrate (pure) (%) | 0.16 | 0.11 |
| Water (%) | 3 | 2.5 |
| Dry matter (%) | 97 | 97.5 |
| Energy (kJ/100 g) | 1560 | 2070 |

“Citrate (pure) (%)” means the amount of citrate calculated as a pure citrate without metals and possible crystal water.

A lactose free milk powder composition of the invention was composed from the lactose free milk powders of Table 1, sodium citrate and potassium citrate in amounts as shown in Table 2. The milk powders were blended with citrates with dry-blending equipment.

TABLE 2

| Raw material | % |
|---|---|
| Sodium citrate preparation | 1 |
| Potassium citrate preparation | 1 |
| Lactose free whole milk powder | 70 |
| Lactose free skim milk powder | 28 |
| Total | 100 |

The lactose free milk powder composition of the invention of Table 2 contains about 34% of protein, about 20% of fat, about 34% of carbohydrates, about 0.06% of lactose, about 32% of glucose and galactose in total, and about 7.0% of ash. The citrate content of the lactose free milk powder composition is 2.1% calculated as a pure citrate (comprising citrate originated from milk and from the citrate preparations).

### Example 2

A flavoured lactose free low sugar yoghurt of the invention was produced from the lactose free milk powder composition described in Table 2, water and a fruit preparation as follows:

TABLE 3

| Raw material | % in the yoghurt |
|---|---|
| Water | 81.5 |
| Lactose free milk powder composition (Table 2) | 11.5 |
| Fruit preparation (64% sugar) | 7 |
| Total | 100 |

The lactose free powder composition of Table 2 was mixed with water to provide a yoghurt milk of the invention. The yoghurt milk was homogenized at 60° C. and at a first step at 150 bar and a second step at 50 bar and then pasteurized at 85° C. for 5 minutes. After pasteurization, the yoghurt milk was cooled to 38° C. A yogurt starter (YoFlex® Creamy 1.0, culture composition: Lactobacillus delbrueckii sub sp. bulgaricus, Lactobacillus rhamnosus, Streptococcus thermophilus); 500 U/2500 L) was added to the cooled yoghurt milk. Incubation with the starter was carried out at 38° C. until pH of 4.6 of a yoghurt mass was reached. The yoghurt mass was cooled to 20° C. The resultant unflavoured yoghurt contained 4.4% of protein, 2.4% of fat, 0% of lactose, 0.9% of ash, 600 mg/kg of sodium, and 1400 mg/kg of potassium.

Fruit preparation was added to the unflavoured yoghurt. The resultant flavoured yoghurt (Ex. 2) was packaged to a container.

The flavoured yoghurt of Table 3 contained 4.0% of protein, 2.2% of fat, 8.4% of carbohydrates (of which 8.3% of sugars), 0% of lactose and 0.1% of NaCl. The energy content of the yogurt milk was 292 kJ (69 kcal).

A reference yogurt (Ref. Ex. 2) was produced from a lactose free milk powder composition of Table 2 consisting of a lactose free skim milk powder and a lactose free whole milk powder without citrate addition. The lactose free milk composition was mixed with water to provide a yoghurt milk. The yoghurt milk was then processed to yoghurt in a similar manner as the yoghurt milk of the invention.

The citrate content of the yoghurts was determined enzymatically according to the IDE method mentioned above. The flavoured yoghurt of the invention contained 0.22% of citrate and 0.89% of ash. The reference yoghurt contained 0.15% of citrate reflecting a citrate level lower than that naturally present in milk, and 0.80% of ash.

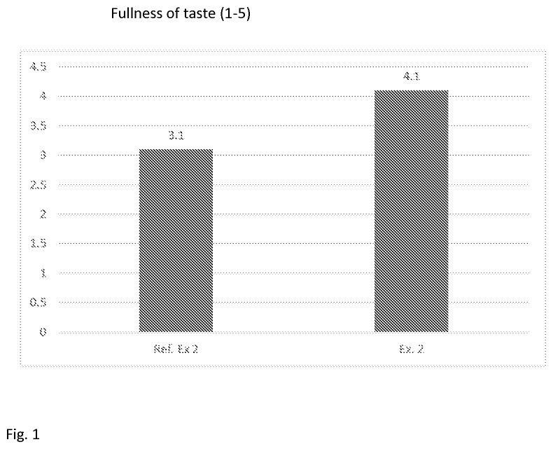

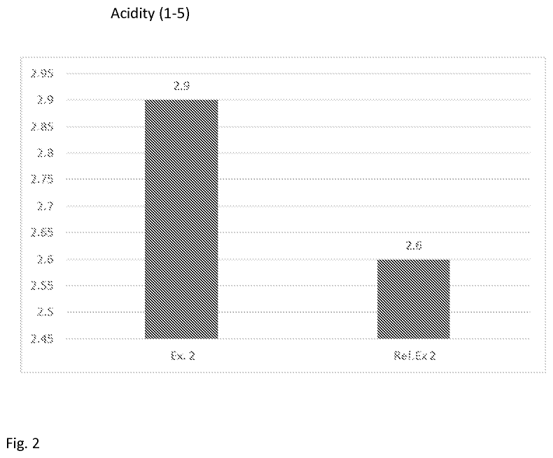

Sensory properties of the yoghurts were tested. Total number of participants (N) in the test was 10. FIG. 1 shows the results relating to fullness of flavour in sensory scores 1-5 (1=empty flavour; 5=rich flavour). FIG. 2 shows the results relating to sense of acidity in sensory scores 1-5 (1=lack of acidity; 5=plenty of acidity). The results show that the yoghurt of the invention (Ex. 2) with a citrate addition was perceived as more full-flavoured, more rounded and more acidic than the reference yoghurt without citrate addition (Ref. Ex. 2). The reference yoghurt was perceived to have bland, empty taste. The difference in sensory scores is statistically significant.

The content of a detectable aroma compound, i.e., diacetyl, was also analysed. The content of diacetyl was determined by using HS-SPME-GC-QTOF techniques (Headspace—Solid-phase Micro Extraction—Gas Chromatography—Mass Spectrometry).

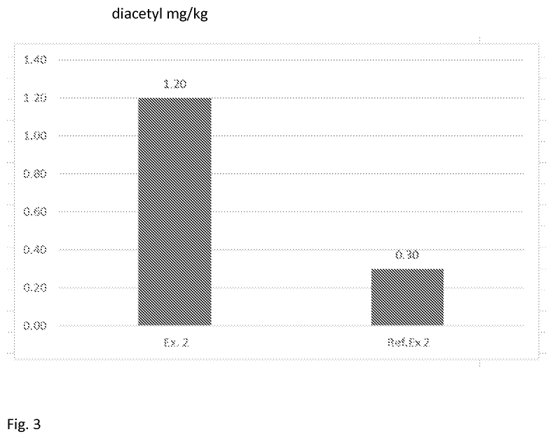

FIG. 3 shows that in the yoghurt prepared according to the invention (Ex. 2) the concentration of diacetyl is four times higher than in the reference yoghurt (Ref. Ex 2). Diacetyl is a typical aroma compound in yoghurt. Diacetyl is given as mg/kg in FIG. 3.

It will be obvious to a person skilled in the art that, as the technology advances, the inventive concept can be implemented in various ways. The invention and its embodiments are not limited to the examples described above but may vary within the scope of the claims.

1.-51. (canceled)

52. A lactose free milk powder composition comprising citrate in an amount of about 1.5% to about 2.5%, on dry matter basis, calculated as pure citrate,
wherein the lactose free milk powder composition is lactose hydrolysed, and
wherein the composition contains at most 0.1% of lactose.

53. The lactose free milk powder composition of claim 52, wherein the composition contains about 30% to about 40% of glucose and galactose in total.

54. The lactose free milk powder composition of claim 52, wherein the composition contains protein in an amount of about 30% to about 50%.

55. The lactose free milk powder composition of claim 52, wherein the composition contains fat in an amount of about 1% to about 30%.

56. The lactose free milk powder composition of claim 52, wherein the composition contains ash in an amount of about 6% to about 10%.

57. The lactose free milk powder composition of claim 52, wherein the composition comprises lactose free whole milk powder, lactose free skim milk powder, a sodium citrate and a potassium citrate.

58. The lactose free milk powder composition of claim 52, wherein the energy content of the composition is about 1500 kJ/100 g to about 2100 kJ/100 g.

59. The lactose free milk powder composition of claim 52, wherein the sodium content of the composition is in the range of about 300 mg/100 g to about 500 mg/100 g.

60. The lactose free milk powder composition of claim 52, wherein the potassium content of the composition is in the range of about 1400 mg/100 g to about 2000 mg/100 g.

61. The lactose free milk powder composition of claim 52, wherein the calcium content of the composition is in the range of about 1000 mg/100 g to about 1500 mg/100 g.

62. The lactose free milk powder composition of claim 52, wherein the magnesium content of the composition in the range of about 90 mg/100 g to about 120 mg/100 g.

63. A method for producing a lactose free milk powder composition comprising the steps of:
providing a milk raw material,
reducing the lactose content of the milk raw material to provide a lactose-reduced milk raw material,
adding at least one of milk, cream and milk minerals to the lactose-reduced milk raw material,
subjecting the lactose-reduced milk raw material to lactose hydrolysis to provide a lactose free milk formulation,
drying the lactose free milk formulation to provide a powdered lactose free milk formulation,
adding a citrate preparation to the powdered lactose free milk formulation to provide a lactose free milk powder composition.

64. The method of claim 63, wherein the milk raw material has a fat content in the range of about 0.1% to about 4.7%.

65. The method of claim 63, wherein the reduction of lactose is carried out by ultrafiltration of the milk raw material.

66. The method of claim 63, wherein the citrate preparation is added in an amount of about 1% to about 3%.

67. The method of claim 63, wherein the citrate preparation comprises a potassium citrate, a sodium citrate and a mixture thereof.

68. The method of claim 63, wherein the lactose free milk powder composition comprises citrate in an amount of about 1.5% to about 2.5%, on dry matter basis, calculated as pure citrate.

69. The method of claim 63, wherein the lactose free milk powder composition contains at most 0.1% of lactose, and about 30% to about 40% of glucose and galactose in total.

70. The method of claim 63, wherein the lactose free milk powder composition contains protein in an amount of about 30% to about 50%.

71. The method of claim 63, wherein lactose free skim milk powder is produced.

72. The method of claim 63, wherein lactose free whole milk powder is produced.

73. The method of claim 63, wherein the lactose free milk powder composition contains ash in an amount of about 6% to about 10%.

74. A method for producing a lactose free low sugar acidified milk product, comprising the steps of:
providing a lactose free milk powder composition comprising citrate in an amount of about 1.5% to about 2.5% on dry matter basis, calculated as pure citrate,
wherein the lactose free milk powder composition is lactose hydrolysed, and
wherein the composition contains at most 0.1% of lactose, or;
providing a lactose free milk powder composition comprising the steps of:
providing a milk raw material,
reducing the lactose content of the milk raw material to provide a lactose-reduced milk raw material,
adding at least one of milk, cream or milk minerals to the lactose-reduced milk raw material,
subjecting the lactose-reduced milk raw material to lactose hydrolysis to provide a lactose free milk formulation,
drying the lactose free milk formulation to provide a powdered lactose free milk formulation,
adding a citrate preparation to the powdered lactose free milk formulation to provide a lactose free milk powder composition,
mixing the lactose free milk powder composition with a liquid to provide a yoghurt milk,
homogenizing the yoghurt milk,
pasteurizing the yoghurt milk, and
fermenting the yoghurt milk with a yoghurt culture to provide a lactose free low sugar acidified milk product.

75. The method of claim 74, wherein the lactose free yoghurt milk contains at most 0.01% of lactose.

76. The method of claim 74, wherein the yoghurt milk comprises about 4.5% to about 5.0% of glucose and galactose.

77. The method of claim 74, wherein the yoghurt milk comprises about 2.5% to about 8% of protein.

78. The method of claim 74, wherein the yoghurt milk contains about 0.1% to about 10% of fat.

79. The method of claim 74, wherein the yoghurt milk contains about 0.5% to about 1% of ash.

80. The method of claim 74, wherein the yogurt culture is selected from St thermophilus and Lb bulgaricus and lactis acid bacteria and a mixture thereof.

81. The method of claim 74, wherein the pH of the lactose free low sugar acidified milk product is about 4.4 to about 4.6.

82. The method of claim 74, wherein the total sugar content of the lactose free low sugar acidified milk product is in the range of about 4% to about 8.4%.

83. The method of claim 74, wherein the lactose free low sugar acidified milk product is yoghurt containing about 3% to about 5% of protein, about 0.1% to about 10% of fat, and about 4% to about 8.4% of sugars in total.

84. The method of claim 74, wherein the lactose free low sugar acidified milk product had a citrate content of about 0.2% to about 0.25%% calculated as a pure citrate.
